(19) United States
(12) Patent Application Publication
(10) Pub. No.: US 2025/0357871 A1
(43) Pub. Date: Nov. 20, 2025

(54) BATTERY POWERED TURBINE GENERATOR

(71) Applicant: John Givhan, Jr., Adamsville, AL (US)

(72) Inventor: John Givhan, Jr., Adamsville, AL (US)

(21) Appl. No.: 18/665,947

(22) Filed: May 16, 2024

(51) Int. Cl. H02M 7/64; H02J 7/00

(52) U.S. Cl. CPC H02M 7/64; H02J 7/0063; H02J 2207/20; H02J 2310/18

(57) ABSTRACT

The present invention is directed at a battery powered turbine generator that can operate continuously, regardless of environmental conditions. This inexpensive system can operate regardless of night or day, in sunlight or wind, and does not require any fossil fuels.

### BACKGROUND OF THE INVENTION

The present invention relates to renewable energy creation and, more particularly, to battery powered turbines.

Most of the energy production in the world still produces greenhouse gas emissions that contribute to poor health and the rise of climate change around the world. The world lacks safe, sustainable, low-carbon, and cheap large-scale energy alternatives to fossil fuels. Currently available systems require large amounts of land to operate, and they are very expensive to install. These systems are also limited to operating within predetermined environmental conditions.

As can be seen, there is a need for a large-scale energy source that is safe, sustainable, low-carbon, inexpensive, compact, and is not limited to use within specific environmental conditions.

The present invention provides a scalable battery powered turbine (BPT) system that can operate continuously, regardless of environmental conditions. This inexpensive system can operate regardless of night or day, in sunlight or wind, and does not require any fossil fuels. This method of battery powered turbine technology and power plant design does not produce air pollution or greenhouse gases when operating. Replacing or reducing the use of non-renewable energy sources with BPT energy may have a positive, indirect effect on the environment.

### SUMMARY OF THE INVENTION

In one aspect of the present invention, the present invention relates to renewable energy creation and, more particularly, to battery powered turbines.

In another aspect of the present invention, the present invention provides a scalable battery powered turbine (BPT) system that can operate continuously, regardless of environmental conditions. This inexpensive system can operate regardless of night or day, in sunlight or wind, and does not require any fossil fuels. This method of battery powered turbine technology and power plant design does not produce air pollution or greenhouse gases when operating. Replacing or reducing the use of non-renewable energy sources with BPT energy may have a positive, indirect effect on the environment.

These and other features, aspects and advantages of the present invention will become better understood with reference to the following drawings, description, and claims.

### BRIEF DESCRIPTION OF THE DRAWINGS

FIG. 1 is a schematic view of a preferred embodiment of the present invention; and

FIG. 2 is an electrical schematic of a preferred embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a battery-powered direct drive DC motor configured to turn multiple turbines that deliver 3-phase AC that is fed through a bridge rectifier to convert power from three phase AC to DC voltage.

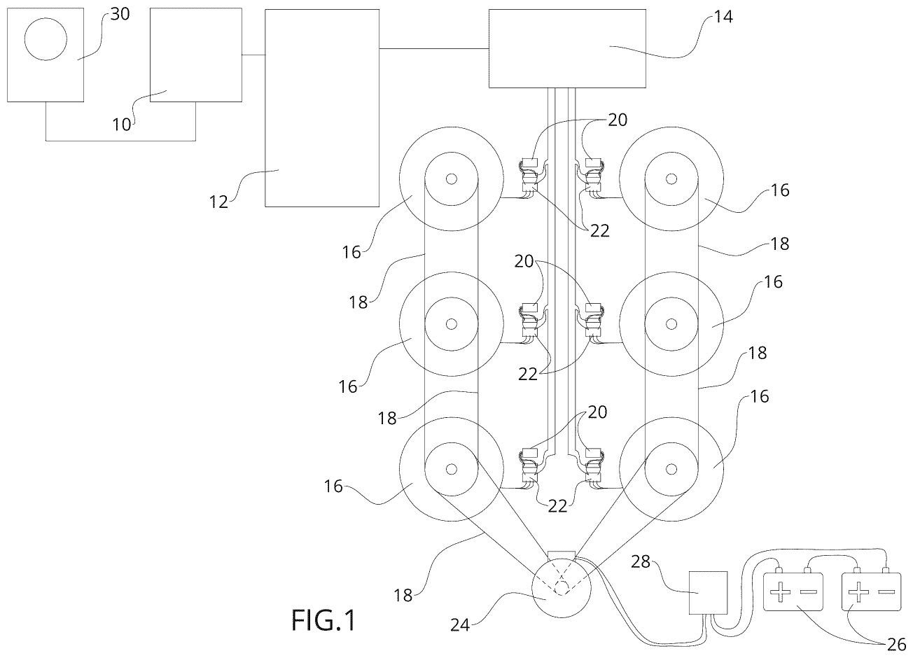

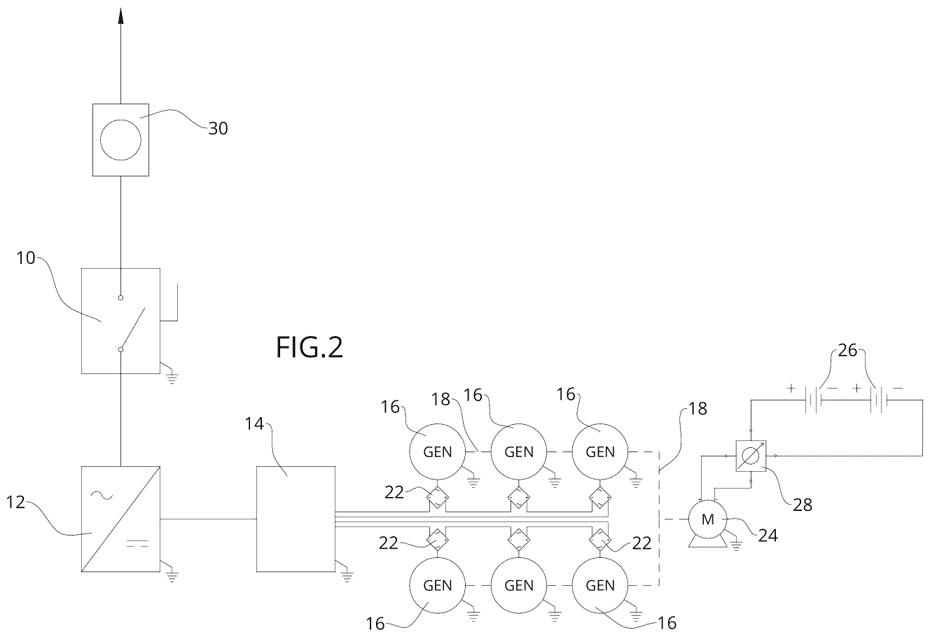

As seen in FIGS. 1 and 2, broadly speaking, in a preferred embodiment the system comprises a utility meter 30 electrically connected to a fused safety switch 10, which is connected to inverter unit 12 that is connected to an AC combiner box 14. In a preferred embodiment, the system comprises six direct drive turbine motors 16, three on one side and three on the other. The three left hand side motors 16 are connected via a first drive belt 18, while the three right hand side motors 16 are connected by a second drive belt 18. Each direct drive turbine motor 16 is also connected to a corresponding 3-phase bridge rectifier 22 and a corresponding digital power multimeter 20.

As further seen in FIG. 1, in a preferred embodiment, the last direct drive turbine motor 16 on the left side and the last direct drive turbine motor 16 on the right side, are each connected to a drive motor 24 via drive belts 18. Drive motor 18 is in turn connected to speed controller 28 and two deep cycle batteries 26.

The battery powered turbine system may be used as a power input device, generating from about 1 KW to about 1 MW of clean and renewable energy for distribution to on- and off-grid systems.

More specifically, in a preferred embodiment, the system of the present invention may be powered with at least two rechargeable deep cycle batteries 26, such as 12V-200 Ah/20 hr batteries.

The batteries 26 may be electrically connected to a motor speed controller switch/regulator 28, such as a 12-80V PWM DC 40A.

Regulated power from the batteries 26 may run a low voltage motor 24, for example, a Leeson C4D-17FK8D motor, 0.75 HP, 1800 RPM, 24 V, 56C Frame, TEFC-108052.00.

The low voltage DC motor 24 may drive one or more turbines 16 (e.g., Fisher & Paykel Technologies, Model No. MB30W63).

A digital power multimeter 20 is connected to each turbine 16 to assure the proper voltage output. Meter 20 may be a DC multifunction battery monitor meter with LCD display, e.g., 0-200V, 0-300A, widely applied to RV Car batteries at 12V, 24V, or 48V. The multimeter 20 may include both ampmeter and voltmeter functions and may monitor both current and voltage.

Each turbine 16 may be electrically connected to a 3-phase bridge rectifier 22, operating for example at 90 AMP, 1000V.

Power from the rectifiers 22 may be combined in a combiner box 14 (e.g., Midnite Solar Inc.).

The combined power may be routed to a DC to AC inverter 12; for example, SUNNY HIGHPOWER PEAK3 125-US SMA America, LLC). The types and sizes of inverter units are not particularly limited.

The system may utilize a main disconnect 10, such as a 200A, 3P+N, 600V Siemens Heavy Duty NEMA 3R-HF364 NR).

The inverter 12 and the main disconnect 10 may be grounded with grounding rods, e.g., ⅝″-10′ with 1 #4 bare copper wire.

The system components may be electrically connected with wire, e.g., 4 #3/0, 1 #6G in a 2″ PVC conduit to the inverter 12, 4 #3/0, 1 #6G in a 2″ PVC underground conduit to the utility meter 30, and 2 (2 #8) THHN-CU in a 1″ PVC conduit.

The system may be constructed in a clearance area compliant with Art. 110-34, National Fire Protection Association publication NFPA 70@-2014.

As an example, and as seen by way of example in FIGS. 1-2, a rechargeable deep cycle battery 26 provides a predetermined voltage to a low voltage motor 24. A DC motor speed controller/regulator 28 controls the low voltage motor speed in rotations per minute (RPMs) set to achieve a predetermined operating voltage. A belt system 18 connected to the low voltage motor 24 drives one or more direct drive turbine motors 16. Each turbine 16 generates from about 60 to 1000 DC Volts. The voltages are then combined at a combiner box 14 and sent to an inverter 12 to be configured for off-grid or grid connected power distribution.

The inventive system may be constructed indoors according to the following method steps. One to about eight turbines 16 (based on the project size) may be mounted on a wall, e.g., 1-inch thick and 4′ wide×8′ tall. Turbines 16 may be placed at least about 7″ or at least about 14″ apart and at least about 15″ off the floor, in two columns, left and right. A drive pulley shaft may be placed on the bottom center of the wall between the left and right turbines. The main drive motor 24 may be bolted to the main pulley shaft and may be wired to a motor speed regulator 28. Regulator 28 may be connected to the main input voltage source 26.

FIGS. 1 and 2 illustrate a system in accordance with a preferred embodiment of the present invention. A rechargeable deep cycle battery 26 or batteries 26 wired to a motor speed controller switch/regulator 28 delivers regulated DC power to a low voltage motor 24. The motor 24 operates direct drive motors 16 by mechanical belt drives 18; in this embodiment, six direct drive motors 16 are shown. A DC multifunction battery monitor meter 20 monitors operation of each direct drive motor 16. Each direct drive motor 16 delivers power to a 3-phase bridge rectifier 22. The rectifiers 22 delivers the power to a combiner box 14 via wiring in a conduit. The combiner box 14 delivers combined current to a DC to AC inverter 12 via a wiring conduit grounded with a grounding rod. The inverter 12 delivers the current to a grounded main disconnect 10, located in a utility service pole. When in operation, the current leaves the main disconnect 10 through a wiring conduit and is delivered to an existing utility meter 30.

It should be understood, of course, that the foregoing relates to exemplary embodiments of the invention and that modifications may be made without departing from the spirit and scope of the invention as set forth in the following claims.

What is claimed is:

1. A battery powered turbine generator system, the system comprising:
one or more rechargeable deep cycle batteries for providing a predetermined voltage to a low voltage motor,
the low voltage motor connected to a DC speed controller for controlling the operating voltage generated by the low voltage motor,
the low voltage motor being connected to a belt drive for driving one or more direct drive turbine motors,
the one or more turbine motors being connected to a combiner box to accept the voltage from the one or more turbine motors,
the combiner box being connected to an inverter to configure the voltage for power distribution.

2. The system of claim 1 wherein the power is configured for grid connected power distribution.

3. The system of claim 1 wherein the power is configured for off-grid power distribution.

4. The system of claim 1 further comprising a 3-phase bridge rectifier connected to each of the one or more turbine motors.

5. The system of claim 4 further comprising a digital power multimeter connected to each of the one or more turbine motors.

6. The system of claim 1 further comprising a fused safety switch connected to the inverter.

7. The system of claim 6 further comprising a utility meter connected to the fused safety switch.

8. The system of claim 1 further comprising a first three direct drive turbine motors connected in series via a first belt drive, and a second three direct drive turbine motors connected in series via a second belt drive.

9. The system of claim 8, wherein the first belt drive and the second belt drive are each connected to the low voltage drive motor.

10. The system of claim 9, wherein each of the first three direct drive turbine motors and each of the second three direct drive turbine motors are each connected to a corresponding digital power multimeter and to a corresponding 3-phase bridge rectifier.
